(19) United States
(12) Patent Application Publication
(10) Pub. No.: US 2007/0285249 A1
(43) Pub. Date: Dec. 13, 2007

(54) METHOD, APPARATUS AND ARTICLE FOR DETECTION OF TRANSPONDER TAGGED OBJECTS, FOR EXAMPLE DURING SURGERY

(75) Inventors: William A. Blair, San Diego, CA (US); Bruce E. Barnes, Escondido, CA (US); David A. Poirier, Escondido, CA (US)

Correspondence Address: SEED INTELLECTUAL PROPERTY LAW GROUP PLLC, 701 FIFTH AVE, SUITE 5400, SEATTLE, WA, 98104, US

(73) Assignee: RF SURGICAL SYSTEMS, INC., Bellevue, WA (US)

(21) Appl. No.: 11/759,141

(22) Filed: Jun. 6, 2007

Related U.S. Application Data
(60) Provisional application No. 60/811,376, filed on Jun. 6, 2006.

(51) Int. Cl. G08B 13/14

(52) U.S. Cl. 340/572.3

(57) ABSTRACT

A system to detect objects tagged with transponders used in-vivo or proximate a surgical site. The system includes a wand housing, at least one antenna carried by the wand housing, a fuse coupled to the at least one antenna and selectively operable to permanently disable the at least one antenna, and a disable circuit configured to selectively blow the fuse to permanently disable the at least one antenna responsive to a lapse of a defined amount of usage. A pouch holds a transponder and is physically coupleable to objects such as surgical sponges or gauze.

### CROSS-REFERENCE TO RELATED APPLICATION

This application claims the benefit under 35 U.S.C. § 119(e) of U.S. Provisional Patent Application No. 60/811,376 filed Jun. 6, 2006, which is incorporated herein by reference in its entirety.

### BACKGROUND

1. Technical Field

This disclosure generally relates to the detection of the presence or absence of objects tagged with transponders, which may, for example, allow the detection of surgical objects during surgery.

2. Description of the Related Art

It is often useful or important to be able to determine the presence or absence of an object.

For example, it is important to determine whether objects associated with surgery are present in a patient's body before completion of the surgery. Such objects may take a variety of forms. For example, the objects may take the form of instruments, for instance scalpels, scissors, forceps, hemostats, and/or clamps. Also for example, the objects may take the form of related accessories and/or disposable objects, for instance surgical sponges, gauzes, and/or pads. Failure to locate an object before closing the patient may require additional surgery, and in some instances may have serious adverse medical consequences. Such may increase the risk of infection, as well as cause additional pain and/or mental stress to patients.

Surgically acceptable procedures for detecting and removing foreign objects include counting the objects used in the operation. X-ray detection is also used to locate foreign objects. It is not uncommon, however, for object counts to be incorrect. Furthermore, even x-ray detection is not flawless. Despite the fact that objects such as surgical sponges are typically embedded with an x-ray opaque material to make them more readily detectable, surgical sponges are often crushed into very small areas within a flesh cavity, whereby x-rays are not always able to sufficiently highlight them for detection. Furthermore, and most detrimentally, an x-ray is a time delayed detection method because of the requirement for film development (even with quick developing films). A patient will often be completely sutured closed before x-ray results are obtained which may indicate the location of a foreign object within the patient. The detection delay may, therefore, result in the need for the surgical team to re-open the patient, thereby increasing the chance of morbidity from the operation.

Prior art techniques for the detection of foreign objects (aside from x-ray analysis) have typically either been prohibitively costly, involved detection devices which were too large to be meaningfully useful (i.e., they often impeded utilization of the objects they are intended to locate), or simply did not provide effective detection. Exemplary techniques include marker or tag systems using radioactive, electromagnetic, magnetomechanical, or electromechanical detection techniques. A more detailed discussion of such prior known techniques is given in the background sections of the present inventors' above-named prior U.S. Pat. No. 6,026,818, which is hereby incorporated by reference in its entirety.

In theory, electronic locators should be suited to the detection of surgical sponges. As a practical matter, it is difficult to make a small tag element with sufficient signal strength for reliable detection at an economic cost. Increasing the size of a tag element may result in a detrimental effect on the utilization of the object it is intended to locate. For example, surgical sponges, a common item for which detection is desired, are useful because they can be deformed for use. However, deformation often distorts large tag elements, and small tag elements may not provide sufficient signal strength for detection. A non-deformable large tag would effectively eliminate the usefulness of a sponge which is deformed for use. The inventors' prior patent discusses this more extensively in connection with prior known schemes.

Surgical objects such as sponges should be deformable to conform to body cavity work area. If the tags or transponders are shrunk and encapsulated so that they would take up a sufficiently small deformation resistant area within a sponge, they could be used without impeding the function of the sponge. However, as the area of the described tags or transponders is shrunk, their coupling will decrease, making them almost invisible to a typical detection system contemplated for use in surgery.

Some hospitals have instituted procedures which include checklists or requiring multiple counts to be performed to track the use and return of objects during surgery. Such a manual approach is inefficient, requiring the time of highly trained personnel, and is prone to error.

Another approach employs transponders and a wireless interrogation and detection system. Such an approach employs wireless transponders which are attached to various objects used during surgery. The interrogation and detection system includes a transmitter that emits pulsed wideband wireless signals (e.g., radio or microwave frequency) and a detector for detecting wireless signals returned by the transponders in response to the emitted pulsed wideband signals. Such an automated system may advantageously increase accuracy while reducing the amount of time required of highly trained and highly compensated personnel. Examples of such an approach are discussed in U.S. Pat. No. 6,026,818, issued Feb. 22, 2000, and U.S. Patent Publication No. US 2004/0250819, published Dec. 16, 2004.

Although the detector may detect wireless signals returned by the transponder and the relative location of the transponder, the transponder is to be manually removed from the patient's body. Therefore, visual contact must be made with the transponder to successfully remove the transponder together with an attached surgical object in a timely manner. However, since the transponder and the attached surgical object may be inconspicuously lodged inside the patient's body, it may be time consuming to establish visual contact with the transponder.

Furthermore, the transmitter may take the form of a hand-held wand. During use, the wand is held by surgical medical personnel who have just completed surgery and is positioned proximate a surgical site of the patient's body to detect whether the wireless transponders and attached surgical objects remain therein. The close proximity to the surgical site during use, and having the wand held by medical personnel upon conducting surgery on a patient may result in the transfer of bacteria or viruses onto the wand. Thus, a reused wand may be a carrier of bacteria and viruses, which may be transferred to other patients that are to undergo transponder detection.

Consequently, it is desirable to have a transponder and wand that address or alleviate at least some of the abovementioned problems.

### BRIEF SUMMARY

According to one aspect, a system to detect objects tagged with transponders used in-vivo or proximate a surgical site includes a wand housing, at least one antenna carried by the wand housing, a fuse coupled to the at least one antenna and selectively operable to permanently disable the at least one antenna, and a disable circuit configured to selectively blow the fuse to permanently disable the at least one antenna responsive to a lapse of a defined amount of usage.

According to one aspect, a method of operating a system for detecting surgical objects tagged with transponders to be used in-vivo or proximate a surgical site includes using a wand having at least one antenna to locate surgical objects tagged with transponders, determining if a defined amount of usage of the wand has occurred, and permanently disabling the at least one antenna in response to a lapse in the defined amount of usage.

According to another aspect, an article for use in detecting surgical objects used in-vivo or proximate a surgical site includes a pouch having an interior and a closeable opening to selectively provide access to the interior from an exterior thereof, the interior sized to receive and retain a transponder therein, the pouch being coupleable to a surgical object to be used in-vivo or proximate the surgical site.

According to yet another aspect, a method for use in detecting surgical objects used in-vivo or proximate a surgical site includes providing a pouch having an interior and a closeable opening to selectively provide access to the interior from an exterior thereof, the interior sized to receive and retain a transponder therein, locating a transponder in the interior of the pouch, and coupling the pouch to a surgical object to be used in-vivo or proximate the surgical site.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram showing a surgical environment illustrating a medical provider using an interrogation and detection system to detect an object tagged with a transponder in a patient, according to one illustrated embodiment.

FIGS. 2A and 2B are schematic illustrations of a ferrite rod and a transponder, according to one illustrated embodiment.

FIG. 3 is a schematic illustration of a coated transponder formed as a fusiform-shaped object with truncated ends, according to one illustrated embodiment.

FIG. 4 is a schematic illustration of an apparatus for attaching a transponder to the object, according to one illustrated embodiment.

FIG. 5 is a schematic illustration of a pouch sized to retain a transponder, according to one illustrated embodiment.

FIG. 6A is a schematic illustration of a wand, according to one illustrated embodiment.

FIG. 6B is a schematic illustration of an antenna, according to one illustrated embodiment.

FIG. 7 is a schematic illustration of a disable circuit coupled to a wand, according to one illustrated embodiment.

### DETAILED DESCRIPTION

In the following description, certain specific details are set forth in order to provide a thorough understanding of various embodiments of the invention. However, one skilled in the art will understand that the embodiments may be practiced without these details. In other instances, well-known structures, equipment and processes associated with transponder detection devices, including antennas, interrogation circuits, detection circuits, fuses, antenna transmission and resulting structures have not been shown or described in detail to avoid unnecessarily obscuring the description.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combinable in any suitable manner in one or more embodiments.

The headings provided herein are for convenience only and do not interpret the scope or meaning of the claimed invention.

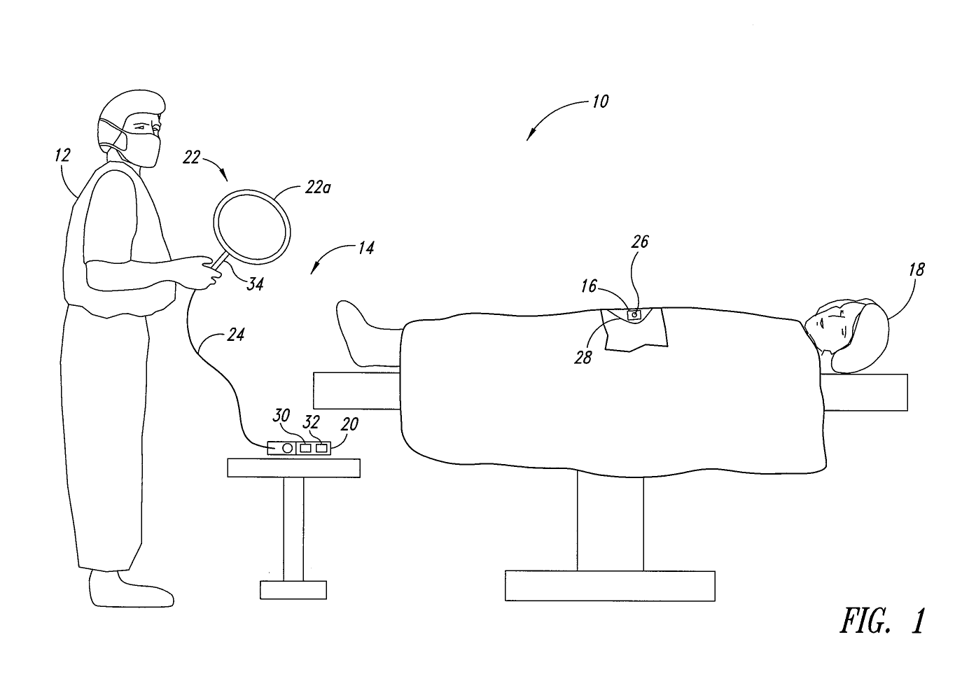

FIG. 1 shows a surgical environment 10 in which a medical provider 12 employs an interrogation and detection system 14 to ascertain the presence or absence of objects 16 in, or on, a patient 18. The interrogation and detection system 14 may include a controller 20, and an antenna 22 coupled to the controller 20 by one or more communication paths, for example, coaxial cable 24. The antenna 22 may take the form of a hand-held wand 22a.

The objects 16 may take a variety of forms, for example instruments, accessories and/or disposable objects useful in performing surgical procedures. For instance, the objects 16 may take the form of scalpels, scissors, forceps, hemostats, and/or clamps. Also for example, the objects 16 may take the form of surgical sponges, gauze and/or padding. The objects 16 are tagged, carried, are attached to or otherwise coupled to a transponder 26. Embodiments of the interrogation and detection system 14 disclosed herein are particularly suited to operate with transponders 26 which are not accurately tuned to a chosen or selected resonant frequency. Consequently, the transponders 26 do not require high manufacturing tolerances or expensive materials, and thus may be inexpensive to manufacture.

In use, the medical provider 12 may position the wand 22a proximate the patient 18 in order to detect the presence or absence of the transponder 26, and hence an object 16. The medical provider 12 may in some embodiments move the wand 22a along and/or across the body of the patient 18. In some embodiments, the wand 22a may be sized to fit at least partially in a body cavity 28 of the patient 18.

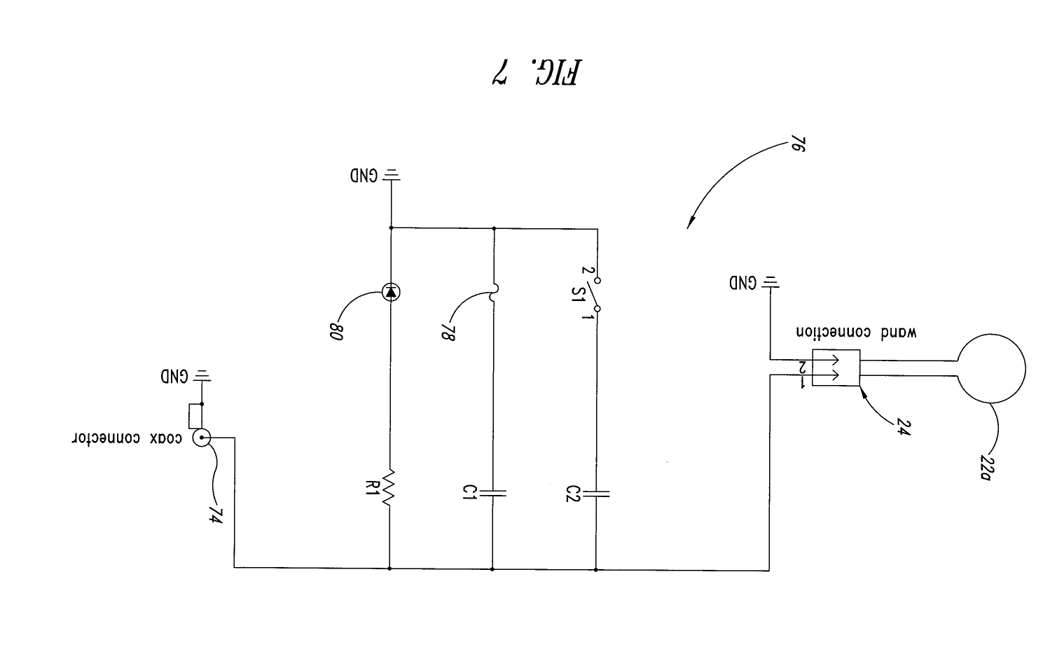

The controller 20 includes an interrogation circuit 30 and a detection circuit 32. The interrogation circuit 30 is operable to drive the antenna 22 to transmit interrogation signals in the form of modulated wideband signals, while the detection circuit 32 is operable to detect return signals received from the transponder 26 via the antenna 22. As will be described herein with reference to FIGS. 6A and 6B, the interrogation and detection circuits 30, 32 may be positioned within a hand-held portion 34 of the wand 22a, according to one embodiment.

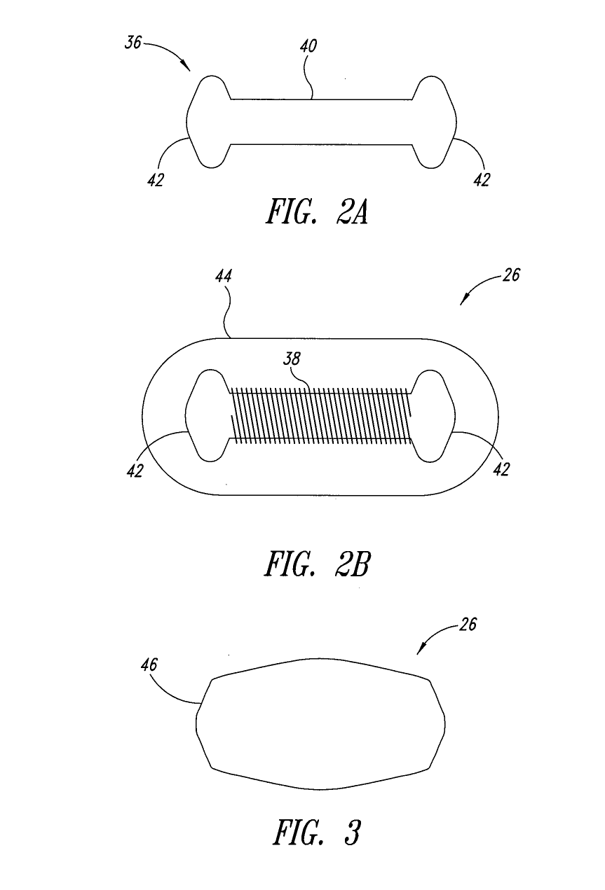

FIGS. 2A and 2B show schematic illustrations of a ferrite rod 36 and the transponder 26, according to one illustrated embodiment.

In embodiments, transponders 26 or tags are comprised of a single signal emitting element such as an encapsulated miniature ferrite rod 36 with wire winding 38, coupled with a capacitive means such as a capacitor for use in a bead embodiment, or a simple single loop wire, with winding, contained within an elastomeric coating as a thread element.

In some embodiments, the ferrite rod 36 may have a dumbbell shape, for example as illustrated in FIG. 1A. Such a dumbbell shaped rod 36 is fashioned to provide a narrower central portion 40, each end of which terminates in a broader portion 42. As illustrated in FIG. 1B, broad portions 42 serve the purpose of containing windings of wire 38 which are wrapped around a narrow portion 40 to form the transponder 26. The transponder 26 may optionally include an encapsulant 44. Such a configuration may be advantageous in that transponders 26 fashioned with dumbbell shaped rods 36 may provide stronger or more reliable signal emission than transponders 26 fashioned with cylindrical ferrite rods.

In some embodiments, a coated transponder 26 is formed as a fusiform-shaped object 46 with truncated ends, as illustrated in FIG. 3. The fusiform shape may be advantageous over cylindrical shaped transponders 26 in reducing the likelihood of close parallel tag alignment associated with tag-tag interaction and interference that otherwise might reduce the efficacy of embodiments.

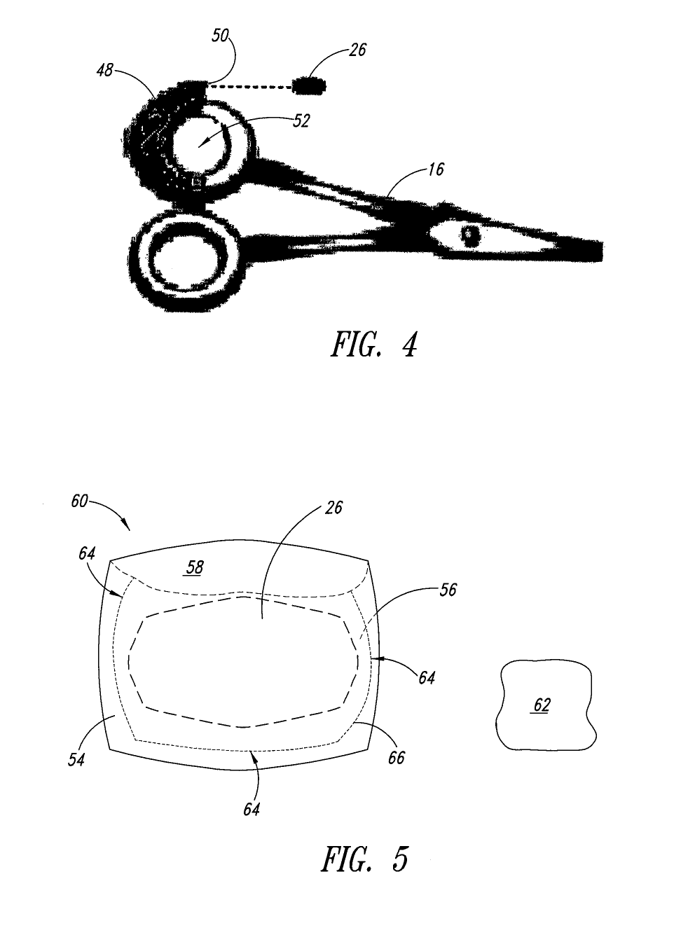

FIG. 4 shows an apparatus 48 for attaching the transponder 26 to the object 16, according to one illustrated embodiment.

The apparatus 48 may be advantageous for detection of objects 26 used in-vivo or proximate a surgical site. In some embodiments in which transponders 26 are used for detecting objects 16 having finger and/or thumb holes (e.g., hemostats, scissors, certain forms of forceps and the like), the apparatus 48 may comprise a clamp or a holder to retain the transponder 26 in conjunction with the object 16, as illustrated in FIG. 4. In some embodiments, the apparatus 48 retains the transponder 26 in a cavity 50 within the apparatus 48. In some embodiments, the apparatus 48 and transponder 26 retained therein are of a durable deformable material, such as surgical grade polymer, which may be deformed to clamp securely onto a finger or thumb hole 52 of the object 16, thereby securely retaining the transponder 26 proximate the object 16 and enabling detection of the presence of the object 16 by detecting the presence of the transponder 26 physically coupled thereto.

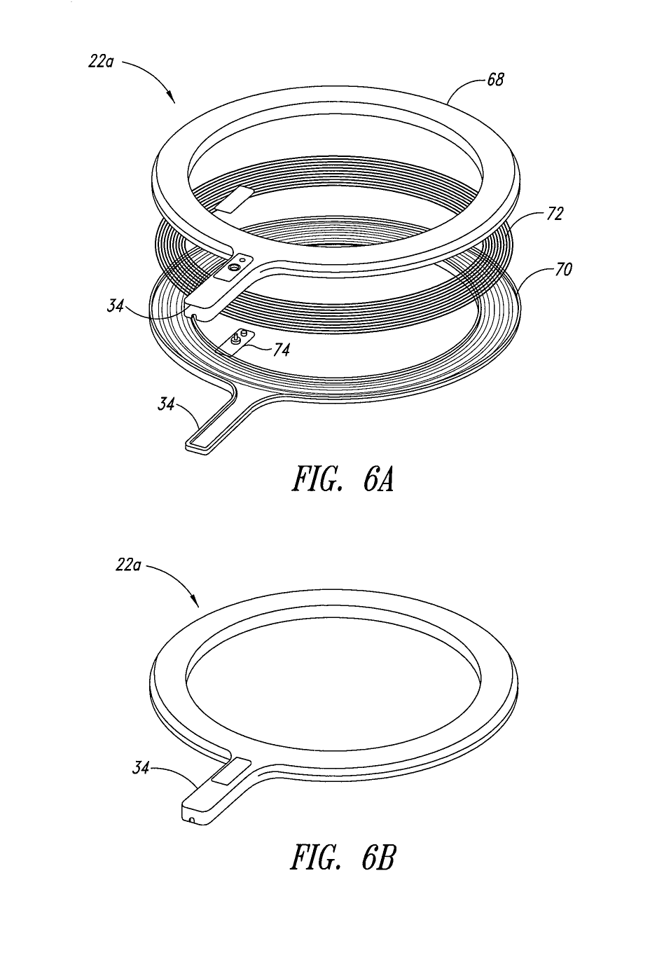

FIG. 5 shows a pouch 54 sized to retain the transponder 26, according to one illustrated embodiment.

According to some embodiments, the transponder 26 is attached to the object 16 used in vivo or proximate the surgical site by way of the pouch 54. The pouch may be fashioned of sheet material (e.g., surgical fabric, cotton, etc.) surrounding the transponder 26.

As illustrated in FIG. 5, the transponder 26 is retained within the pouch 54. According to one embodiment, the pouch 54 is sewn around the transponder 26. The pouch 54 provides material that may be attached by a fastening means to the object 16 in the surgical environment, whereby detection of the transponder 26 retained by the fastened pouch 54 indicates the proximate presence of the object 16. The means for fastening the pouch 54 to the object 16 may include sewing with fiber, adhering with adhesive, adhering with polymer such as hot glue, clamping, grommeting and the like. It will be appreciated by those of skill in the art that the various embodiments contemplate these and all other means for fastening the pouch 54 to the object 16.

The pouch 54 includes an interior 56 and may includes a closeable opening 58 to selectively provide access to the interior 56 from an exterior 60 thereof. The interior 56 is sized to receive and retain the transponder 26 therein. The opening 56 may be sewn shut to securely retain the transponder 26 in the interior 56 of the pouch 54. The pouch 54 may be coupled or fixed to the surgical object 16 by at least one of a fiber, an adhesive, a polymer, a clamp or a grommet.

The pouch 54 may be coupled or fixed to a surgical sponge 62, for example, by being sewn to or into the surgical sponge 62. Furthermore, the pouch 54 may be deformable and/or flexible such that the pouch 54 does not interfere with the functionality of the surgical sponge 62 when fixed thereto. The pouch 54 may be formed of a material (e.g., cotton) having a sufficiently high thread count to allow the pouch 54 to be securely sewn or otherwise attached to a piece of gauze or similar low thread count or wispy material.

In one embodiment, the pouch 54 is stitched around the perimeter 64 thereof, except for the opening 58. The partially sewn pouch 54 is turned inside out to form a pillow case structure, with stitches 66 in the interior 56 of the pouch 54. The pouch 54 may advantageously be of a color that is distinguishable from the surgical environment to better highlight the pouch 54 and thereby ease visual detection of the pouch 54 and the object 16 coupled thereto.

FIG. 6A shows the wand 22a and FIG. 6B shows an antenna 22, according to one illustrated embodiment.

According to some embodiments, the antenna 22 is shared by both the interrogation circuit 30 and the detection circuit 32. In one embodiment, an impedance of the antenna 22 is matched with an impedance of the interrogation circuit 30. The antenna 22 may include a single ring-shaped antenna or plural ring-shaped antennas.

According to some embodiments, the medical provider 12 may move the wand 22a along and/or across the body of the patient 18 within approximately 12 to 18 inches of proximity to the patient 18 and the surgical site, for verification of object 16 removal. A head of the wand 22a may include a single ring-shaped antenna or plural ring-shaped antennas. The wand 22a or head of the wand may advantageously be disposable.

In some embodiments, the antenna 22 is an annulus or air-coil, formed of coils of wire. For example, in one embodiment, the antenna 22 consists of 1/10th center turns spacing on an inner diameter of about 11 inches and an outer diameter of about 14 inches. As illustrated in FIG. 6A, the wand 22a housing may include an upper portion 68 and lower portion 70 that enclose windings 72. As will be appreciated by those of skill in the art, the present disclosure teaches a number of preferred embodiments that comprise wire coils, wherein coil turns are optimized against total inductance and wire spacing limits.

According to at least one embodiment (FIG. 1), both the interrogation and detection circuits 30, 32 are located distally or separately from the wand 22a and antenna 22. In other embodiments (FIGS. 6A and 6B), the hand-held portion 34 of the wand 22a includes circuitry 74 which may include some or all of the electronics providing the interrogation and detection functionality for interacting with the transponders 16 and detecting the proximity of the transponders 16. In particular, the circuitry 74 may include the interrogation and detection circuits 30, 32. Alternatively, or additionally, the circuitry 74 may include user interface elements (e.g., LEDs, LCDs, speaker, etc.) and/or a connector to the coaxial cable 24 to establish a communication path between the antenna 22 and separately housed interrogation circuit 30 and/or detection circuit 32.

Cabling (e.g., coaxial cable 24) comprising a plurality of conductors may be supplied to the wand 22a to establish a signal and/or current connections to the wand 22a. Such may provide communications between the antenna 22 positioned in the wand 22a and the separately housed interrogation and detection circuits 30, 32.

FIG. 7 shows a schematic illustration of the circuitry 76 carried by the wand 22a, according to one illustrated embodiment. The circuitry 76 may implement a variety of functions, some of which are discussed immediately below.

According to one embodiment, the wand 22a is a disposable wand. The circuitry 76 may implement a disable functionality that advantageously prevents reuse of the wand 22a. This may, for example, prevent the wand 22a from being used for surgeries on different patients.

The circuitry 76 may, for example, include a fuse 78 that is selectively operable or “blowable” to permanently disable the antenna 22. In contrast to the typical use of fuses to protect circuitry or individuals from anomalous operating conditions, the fuse 78 is blown even in absence of an anomalous condition, while the circuitry 76 is operating normally. The fuse 78 is preferably irreplaceable or cannot be replaced without reconditioning of the wand 22a by the original manufacturer.

The circuitry 76 may be configured to selectively blow the fuse 78 to permanently disable the antenna 22 in response to a lapse, passage or occurrence of a defined amount of usage. For example, the circuitry 76 may be configured to selectively blow the fuse 78 upon determining that a defined amount of time has elapsed after the antenna 22 has begun to transmit the interrogation signals or after the antenna 22 or wand 22a has been switched into an ON state. The circuitry 76 blows the fuse 78 by intentionally producing an over current through the fuse 78. Some embodiments may provide the over current to the circuitry 76 of the wand 22a via the cable 24.

The defined amount of usage may be unchangeably set by the circuitry 76. According to some embodiments, blowing the fuse 78 disconnects the antenna 22 from interrogation and detection circuits 30, 32 housed in the wand 22a. In other embodiments, blowing the fuse 78 disconnects the antenna 22 from separately housed interrogation and detection circuits 30, 32 (FIG. 1). Alternatively, the circuitry 76 may use a resonance check to determine a varied capacitance C1 in a series path of the fuse 78. Furthermore, in some embodiments the circuitry 76 cooperates with a wireless test apparatus, described below.

In some embodiments, the circuitry 76 includes one or more user interface elements, for example, an indicator such as an LED 80. As illustrated in FIG. 7, the indicator light 80 operates without need for an additional cable lead by way of a suitably sized resistor R1 enabling current flow through LED 80 when the antenna 22 is active.

In some embodiments, the circuitry 76 may also include a switch S1. In the illustrated embodiment of FIG. 7, the switch S1 is able to start (enable) and stop (disable) the antenna 22 without the use of additional cable leads by employing a capacitance C2 to vary the resonance of a wand circuit indicating a switch state.

In operation, performance of the various embodiments may be optimized by designing the interrogation and detection circuits 30, 32 to practice relatively short transmit cycles with a relatively wide bandwidth. For example, embodiments have utilized a 240 microsecond transceive cycle with the cycle comprising 90 μsec. transmit, 10 μsec. drain, 10 μsec. recover, and 130 μsec. receive for signal accumulation. It has been found that, as signal bandwidth is increased, the transmit cycle is shortened to good effect.

Embodiments may practice fast Fourier transformation on accumulated received signals for reduction of signal to noise ratio. Some embodiments may further reduce signal to noise ratio by practicing adaptive noise reduction. In such embodiments, ambient noise is sampled and removed from the signals received by the detection circuit 32. In some such embodiments, ambient noise levels are sampled by a second antenna/receiving means disposed distal from a target area. Signals that are transmitted by transponders 26 in the target area, in response to transmissions from the interrogation circuit 30, are sufficiently attenuated distally from the target area so that signals received by the second antenna will substantially comprise noise, such noise serving as a baseline for adaptive noise cancellation of signals received by the detection circuit 32 proximate the target area.

The technology taught by the various embodiments taught herein may also effectively be employed to detect objects to which RFID tags are attached. As is well known to those in the art, RFID is a method of remotely storing and retrieving data in RFID tags. RFID tags, in contrast with the tags or transponder of the previously discussed embodiments, comprise more complex electronics which respond with data when queried by an RFID transceiver. In response to properly adjusted pulse duration and bandwidth, however, RFID tags can provide signature responses which are detectable by the detection circuit 32 in a manner similar to that associated with the tags or transponders previously discussed herein above.

In normal operation, a remote transmitter transfers power to a passive RFID tag via a radio frequency signal. The RFID tag utilizes the power thereby obtained to transmit data in response to remote query. Appropriate adjustment of the transmit cycle of the present invention can effectively emulate the requisite narrowband signal required by the RFID tag for power transfer.

Some embodiments can accommodate applications in which both data (RFID) tags and “dumb” tags (as taught hereinabove) are present. While data tag devices use collision avoidance methods, they are not designed to interoperate with wideband, frequency-interleaved dumb tags. However, in some embodiments, the transceiver timing model is interleaved between that required for data tags and that required for dumb tags, thereby enabling detection of either such tag in the target area.

In alternative embodiments, accommodating detection of either data or dumb tags, separate detection circuitry, one such circuitry adapted for detection of data tags and one adapted for detection of dumb tags may be employed sharing a single form factor and user interface. In some such embodiments, the two sets of circuitry may share a single antenna/wand.

Within the scope of embodiments is a wireless test apparatus for manufacturing. In a variation of the traditional drip grid meter, the apparatus utilizes the presently disclosed technology to pulse components and make measurements with a special wand/meter adapted for such purpose. This technology enables rapid leadless measurement of Q, frequency, and amplitude of wire-wound coils and wire-wound ferrite components. The improvement for testing is extremely rapid measurement. Parts can be measured in 60-100 ms and moved through the test line without physical connection. Unlike traditional grid-dip devices the amplitude of resonant frequency response is accurately captured. The antenna is specially designed to accommodate a small read area for line art testing, and because of its high inductance, requires modified timing to accommodate the associated energy drain.

Accordingly, it will be appreciated by those of skill in the art that the various embodiments are directed to a cost effective tag or transponder element for detecting objects (in particular objects in the surgical environment), along with a wideband detection device for use in conjunction with such a tag. The various embodiments further describe a number of improvements in such technology. Further yet, embodiments contemplate a wireless apparatus employing technology along the same lines in the manufacturing environment. Based upon the foregoing description, these and other improvements, advantages, features and characteristics of the present disclosure will be appreciated by those of skill in the art, who are thereby enabled to make and use the same.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system to detect surgical objects tagged with transponders used in-vivo or proximate a surgical site, the system comprising:
a wand housing;
at least one antenna carried by the wand housing;
a fuse coupled to the at least one antenna and selectively operable to permanently disable the at least one antenna; and
a disable circuit configured to selectively blow the fuse to permanently disable the at least one antenna responsive to a lapse of a defined amount of usage.

2. The system of claim 1, further comprising:
an interrogation circuit coupled to drive the at least one antenna to transmit interrogation signals in the form of modulated wideband signals.

3. The system of claim 2 wherein the interrogation circuit is housed separately from the wand, and coupled thereto by a coaxial cable.

4. The system of claim 2 wherein the interrogation circuit is housed within the wand.

5. The system of claim 2 wherein an impedance of the antenna is matched with an impedance of the interrogation circuit.

6. The system of claim 1, further comprising:
a detection circuit coupled to the at least one antenna to detect return signals returned from one or more transponders in response to the interrogation signals.

7. The system of claim 6 wherein the detection circuit is housed separately from the wand, and coupled thereto by a coaxial cable.

8. The system of claim 6 wherein the detection circuit is housed within the wand.

9. The system of claim 2 wherein the wand housing includes a handle sized to be grasped.

10. The system of claim 9 wherein the wand housing includes an annular portion extending from the handle, the at least one antenna housed in the annular portion.

11. The system of claim 10 wherein the at least one antenna includes a plurality of rings.

12. The system of claim 10 wherein the defined amount of usage is unchangeably set by the disable circuit.

13. The system of claim 1 wherein the disable circuit produces an over current through the fuse in response to the lapse of the defined amount of usage.

14. The system of claim 1 wherein the fuse is irreplaceable.

15. A method of operating a system for detecting surgical objects tagged with transponders to be used in-vivo or proximate a surgical site, the method comprising:
using a wand having at least one antenna to locate surgical objects tagged with transponders;
determining if a defined amount of usage of the wand has occurred; and
permanently disabling the at least one antenna in response to a lapse in the defined amount of usage.

16. The method of claim 15 wherein permanently disabling the at least one antenna includes permanently blowing a fuse to uncouple the at least one antenna.

17. The method of claim 15 wherein using a wand having at least one antenna to locate surgical objects tagged with transponders includes transmitting interrogation signals in the form of modulated wideband signals from the at least one antenna.

18. The method of claim 15 wherein using a wand having at least one antenna to locate surgical objects tagged with transponders includes receiving at the at least one antenna, return signals returned by the transponder in response to the interrogation signals.

19. The method of claim 18, further comprising:
determining a presence of the object based at least in part on an increased intensity of the return signals received from the transponder.

20. The method of claim 19 wherein the determining the presence of the object based at least in part on an increased intensity of the return signals received from the transponder includes processing the return signals with detection circuitry located remotely from the wand, the wand interchangeably communicatively coupled to the detection circuitry via a coaxial cable.

21. The method of claim 19 wherein the determining the presence of the object based at least in part on an increased intensity of the return signals received from the transponder includes processing the return signals with detection circuitry located within the wand.

22. The method of claim 15 wherein determining if the defined amount of usage of the wand has occurred includes determining whether a defined time has elapsed after the wand has been communicatively coupled to interrogation circuitry located remotely from the wand, the wand interchangeably communicatively coupled to the interrogation circuitry via a coaxial cable.

23. The method of claim 15 wherein determining if the defined amount of usage of the wand has occurred includes determining whether a defined time has elapsed after the wand has been communicatively coupled to interrogation circuitry located within the wand.

24. The method of claim 23, further comprising:
matching an impedance of the at least one antenna with an impedance of the interrogation circuitry.

25. The method of claim 15 wherein determining if the defined amount of usage of the wand has occurred includes determining whether a defined time has elapsed after the at least one antenna has begun to transmit the interrogation signals.

26. The method of claim 15, further comprising:
producing an overcurrent through the fuse in response to the lapse in the defined amount of usage.

27. An article for use in detecting surgical objects used in-vivo or proximate a surgical site, the article comprising:
a pouch having an interior and a closeable opening to selectively provide access to the interior from an exterior thereof, the interior sized to receive and retain a transponder therein, the pouch being coupleable to a surgical object to be used in-vivo or proximate the surgical site.

28. The article of claim 27, further comprising:
a transponder retained within the pouch.

29. The article of claim 28 wherein the opening of the pouch is sewn shut to secure the transponder in the interior of the pouch.

30. The apparatus of claim 27 wherein the pouch is fixed to the surgical object by at least one of a fiber, an adhesive, a polymer, a clamp or a grommet.

31. The article of claim 27 wherein the pouch is fixed to a surgical sponge.

32. The article of claim 27 wherein the pouch is sewn to a surgical sponge.

33. The article of claim 27 wherein the pouch is sewn into a surgical sponge.

34. The article of claim 27 wherein the pouch has a sufficiently high thread count to allow the pouch to be securely sewn to a piece of gauze.

35. The article of claim 27 wherein the pouch is made of cotton and has a sufficiently high thread count to allow the pouch to be securely sewn to a piece of gauze.

36. The article of claim 27 wherein the pouch has a reverse pillow case structure.

37. The article of claim 27 wherein the pouch is of a color that is distinguishable from a surgical environment.

38. The article of claim 27 wherein the pouch is deformable.

39. The article of claim 27 wherein the pouch is flexible.

40. A method for use in detecting surgical objects used in-vivo or proximate a surgical site, the method comprising:
providing a pouch having an interior and a closeable opening to selectively provide access to the interior from an exterior thereof, the interior sized to receive and retain a transponder therein;
locating a transponder in the interior of the pouch; and
coupling the pouch to a surgical object to be used in-vivo or proximate the surgical site.

41. The method of claim 40, further comprising:
sewing the opening closed to securely retain the transponder in the interior of the pouch.

42. The method of claim 40 wherein coupling the pouch to the surgical object to be used in-vivo or proximate the surgical site includes sewing the pouch within a surgical sponge.

43. The method of claim 40 wherein providing the pouch having the interior and the closeable opening includes providing a pillow case structure pouch having stitches about a perimeter thereof located in the interior of the pouch.

44. The method of claim 40, further comprising:
forming the pouch by stitching around a perimeter thereof, except for the opening; and
turning the stitched pouch inside out such that the stitches are in the interior of the pouch.

45. The method of claim 40 wherein providing the pouch having the interior and the closeable opening includes providing a cotton pouch having a sufficiently high thread count to allow the pouch to be securely sewn to a piece of gauze.

46. The method of claim 40 wherein providing the pouch having the interior and the closeable opening includes providing a colored pouch having a color that is distinguishable from a surgical environment.
